(19) United States
(12) Patent Application Publication
(10) Pub. No.: US 2010/0211432 A1
(43) Pub. Date: Aug. 19, 2010

(54) Method and System for Providing Popular Content

(75) Inventors: Paul Yiu, Mountain View, CA (US); Marc Davis, San Francisco, CA (US); Farzin Maghoul, Hayward, CA (US); Jeonghee Yi, San Jose, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/370,860

(22) Filed: Feb. 13, 2009

(51) Int. Cl. G06Q 99/00; G06F 17/30

(52) U.S. Cl. 705/10; 707/E17.001

(57) ABSTRACT

Systems and methods for providing popular content are disclosed. Generally, a request for popular content is received from a device. The request for popular content includes at least one parameter associated with users that previously accessed the popular content. A popularity module identifies the popular content based on a frequency of users associated with the at least one parameter accessing the popular content. The identified popular content is then served to the device.

### BACKGROUND

As interconnected information networks have gained popularity, search queries submitted to search engines and webpage requests submitted to website providers have become useful indicators of what is currently popular in society. While search queries and webpage requests are currently used to determine what is generally popular in society, it is desirable to use search queries and webpage requests to determine what is currently popular in specific geographic areas, at specific times of the day, or even with users having a specific demographic.

### BRIEF DESCRIPTION OF THE DRAWINGS

FIG. 1 is a block diagram of an environment in which systems for providing popular content may operate;

FIG. 2 is a block diagram of a system for providing popular content; and

FIG. 3 is a flow chart of a method for providing popular content.

### DETAILED DESCRIPTION OF THE DRAWINGS

The present disclosure is directed to methods and system for providing popular content. Providing popular content to an information network user based on a series of parameters supplied by the user provides new ways for users to search for information when the user does not necessarily know what they are specifically searching for. For example, a user may wish to search for information on a popular restaurant in Chicago, Ill., but does not know what specific restaurant to search for. Accordingly, the user submits a request for popular content with parameters such as restaurant listings viewed by users in Chicago on a Friday night. A series of webpages, or objects on webpages such as restaurant listings, associated with popular restaurants in Chicago that other users searched for, or viewed, on a Friday night may then be returned to the user.

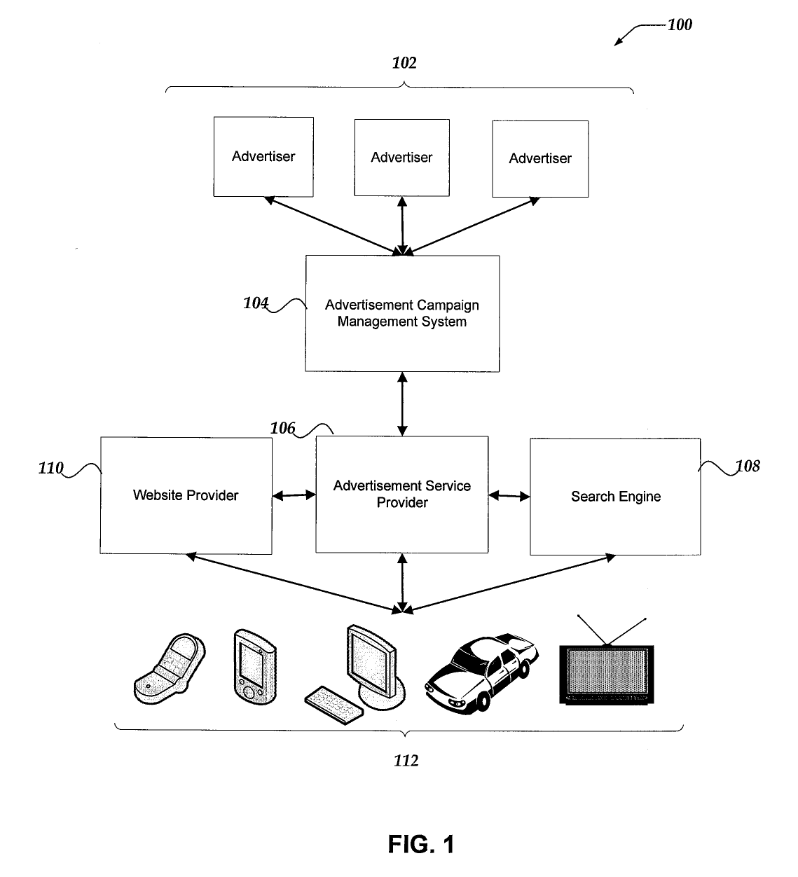

FIG. 1 is a block diagram of an environment in which a system for providing popular content may operate. The environment 100 may include a plurality of advertisers 102, an ad campaign management system 104, an ad provider 106, a search engine 108, a website provider 110, and a plurality of users 112. Generally, an advertiser 102 bids on terms and creates one or more digital ads by interacting with the ad campaign management system 104 in communication with the ad provider 106. The advertisers 102 may purchase digital ads based on an auction model of buying ad space or a guaranteed delivery model by which an advertiser pays a minimum cost-per-thousand impressions (i.e., CPM) to display the digital ad. Typically, the advertisers 102 may select-and possibly pay additional premiums for-certain targeting options, such as targeting by demographics, geography, behavior (such as past purchase patterns), “social technographics” (degree of participation in an online community) or context (page content, time of day, navigation path, etc.). The digital ad may be a graphical ad that appears on a website viewed by a user 112, a sponsored search listing that is served to a user 112 in response to a search performed at a search engine, a video ad, a graphical banner ad based on a sponsored search listing, and/or any other type of online marketing media known in the art.

When a user 112 performs a search at a search engine 108, the search engine 108 typically receives a search query comprising one or more keywords. In response to the search query, the search engine 108 returns search results including one or more search listings based on keywords within the search query provided by the user 112. Additionally, the ad provider 106 may receive a digital ad request based on the received search query. In response to the digital ad request, the ad provider 106 serves one or more digital ads created using the ad campaign management system 104 to the search engine 108 and/or the user 112 based on keywords within the search query provided by the user 112.

Similarly, when a user 112 requests a webpage served by the website provider 110, the ad provider 106 may receive a digital ad request. The digital ad request may include data such as keywords obtained from the content of the webpage. In response to the digital ad request, the ad provider 106 serves one or more digital ads created using the ad campaign management system 104 to the website provider 110 and/or the user 112 based on the keywords within the digital ad request. In some embodiments, including ad-supported applications, the user 112 may access the ad provider 106 directly through a client-based application.

When the digital ads are served, the ad campaign management system 104 and/or the ad provider 106 may record and process information associated with the served digital ads for purposes such as billing, reporting, or ad campaign optimization. For example, the ad campaign management system 104 and/or the ad provider 106 may record the factors that caused the ad provider 106 to select the served digital ads; whether the user 112 clicked on a URL or other link associated with one of the served digital ads; what additional search listings or digital ads were served with each served digital ad; a position on a webpage of a digital ad when the user 112 clicked on a digital ad; and/or whether the user 112 clicked on a different digital ad when a digital ad was served. One example of an ad campaign management system that may perform these types of actions is disclosed in U.S. patent application Ser. No. 11/413,514, filed Apr. 28, 2006, and assigned to Yahoo! Inc., the entirety of which is hereby incorporated by reference.

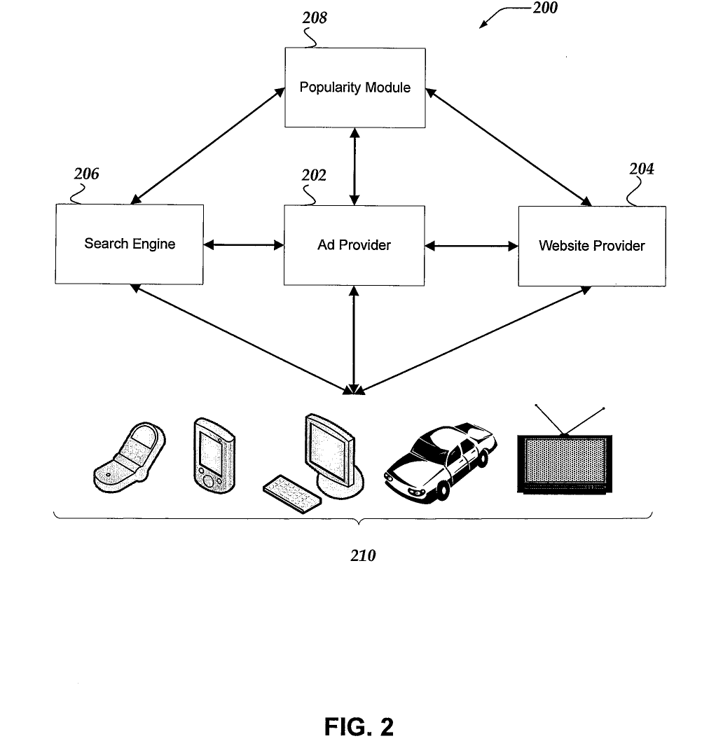

FIG. 2 is a block diagram of a system for providing popular content. Generally, the system 200 comprises an ad provider 202, a website provider 204, a search engine 206, and a popularity module 208. In some implementations, the popularity module 208 may be part of the ad provider 202, website provider 204, or the search engine 206, where in other implementations the popularity of module 208 is distinct from the ad provider 202, website provider 204, and search engine 206.

The ad provider 202, website provider 204, search engine 206, and popularity module 208 may communicate with each other over one or more external or internal networks. The networks may include local area networks (LAN), wide area networks (WAN), and/or the Internet, and may be implemented with wireless or wired communication mediums such as wireless fidelity (WiFi), Bluetooth, landlines, satellites, and/or cellular communications. Further, the ad provider 202, website provider 204, search engine 206, and popularity module 208 may be implemented as software code running in conjunction with one or more processors of a single server, plurality of servers, or any other type of computing device known in the art.

Generally, users 210 send webpage requests to the website provider 204 and search queries to the search engine 206 as described above in conjunction with FIG. 1. As the users 210 interact with search listings, webpages, and digital ads, the ad provider 202, website provider 204, and/or search engine 206 monitor and record the activity of the users 210. For example, the ad provider 202, website provider 204, and/or search engine 206 may record a content type and/or a document type accessed such as a webpage, a mobile webpage, a business listing, a movie listing, an object on a webpage, an image, or a video; a universal resource locator (“URL”) associated with an accessed document; metadata associated with an accessed document; a location associated with an accessed document; a location of an user accessing a document; a time period associated with an accessed document; a time at which a document was accessed; or an author, rating, popularity level, or certification associated with accessed content or an accessed document.

Subsequently, a user 210 submits a request to the website provider 204 and/or the search engine 206 for popular content. The request for popular content includes one or more parameters associated with the desired content such as a location; a time period; a demographic such as a gender, age, or income; or a content or document type such as a webpage, a mobile webpage, a business listing, a movie listing, an image, or a video. For example, a user may submit requests such as a request for information regarding top mobile webpage content viewed in San Francisco, Calif. between 8:00 pm and 9:00 pm on Friday, Aug. 1, 2008; a request for information regarding top movie listings viewed in Chicago, Ill. on a Saturday afternoon for female users between the age of 20 and 30; or a request for information regarding top news articles viewed by users in the District of Columbia during the previous week.

The popularity module 208 processes the received request for information to identify popular content based on a frequency of selection of content by users 210 associated with the received parameters. In one implementation, the popularity module 208 identifies popular content based on a number of times users request content, where the users and/or content is associated with the received parameters. In other implementations, the popularity module 208 identifies popular content based on a number of times users view content, where the users and/or content is associated with the received parameters. In yet other implementations, the popularity module 208 identifies the popular content based on factors such as user interactions with content or a document; a length of user interactions with content or a document; annotations associated with content; popularity of annotations associated with content; or user communications associated with content or a document.

In some implementations, the popularity module 208 adjusts a ranking of the identified popular content based on properties associated with a user requesting the content (also known as w4 conditions) to personalize the identified popular content and/or provide the identified popular content in a contextually relevant manner. For example, the popularity module 208 may adjust the identified popular content based on demographic information associated with a user requesting the popular content; a location of the user requesting the popular content when the request for popular content is submitted; a time of day when the user requesting the poplar content submitted the request for popular content; and/or any content preferences previously established by the user requesting the popular content. Examples of systems and methods for providing contextually relevant data are disclosed in U.S. patent application Ser. No. 12/239,964, titled “System for Providing Contextually Relevant Data,” filed Sep. 29, 2008, and assigned to Yahoo! Inc., the entirety of which is hereby incorporated by reference.

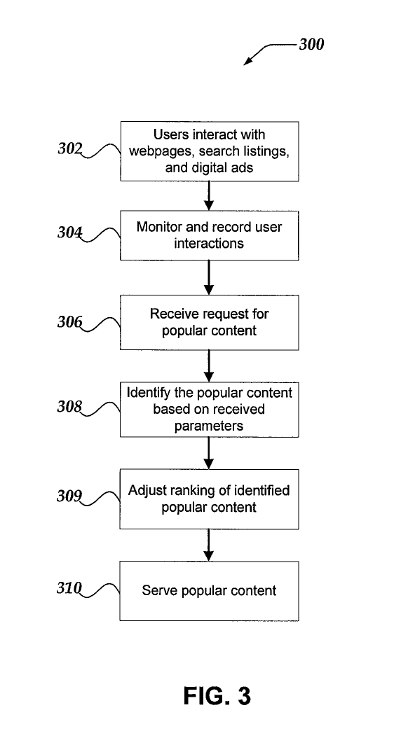

FIG. 3 is a flow chart of a method for providing popular content. The method 300 begins at step 302 with users interacting with search listings, webpages, and digital ads. At step 304, systems such as an ad provider, website provider, and/or search engine monitor the users interactions and record information such as a content type and/or document type accessed, a URL associated with an accessed document, metadata associated with an accessed document, a location associated with an accessed document, a location of an user accessing a document, a time period associated with an accessed document, or a time at which a document was accessed.

At step 306, a user submits a request for information to the ad provider and/or the search engine for popular content. The request for information may include one or more parameters such as a content type, a document type, a location, a time period, or a demographic of a user accessing the popular content. At step 308, a popularity module processes the request for information and identifies popular content associated with the received parameters. As discussed above, the popularity module may identify popular content based on factors such as a number of time users request content, where the users and/or the content is associated with the received parameter, or a number of times users view content, where the users and/or the content is associated with the received parameters.

In some implementations, at step 309 the popularity module adjusts the ranks of the identified popular content based on properties associated with a user requesting the content (also known as w4 conditions) to personalize the identified popular content and/or provide the identified popular content in a contextually relevant manner.

At step 310, the identified popular content is forwarded to the user that requested the popular content at step 306. In some implementations, only the most popular document is forwarded to the user, where in other implementations a top set of popular documents, such as the ten most popular documents, are forwarded to the user.

FIGS. 1-3 disclose systems and methods for providing popular content. As described above, the disclosed systems and methods provide users new ways to search for information when the users do not necessarily know what they are specifically searching for.

It is intended that the foregoing detailed description be regarded as illustrative rather than limiting, and that it be understood that it is the following claims, including all equivalents, that are intended to define the spirit and scope of this invention.

1. A method for providing popular content, the method comprising:
receiving a request for popular content from a device, the request for popular content comprising at least one parameter associated with users that previously accessed the popular content;
identifying the popular content based on a frequency of users associated with the at least one parameter accessing the popular content; and
serving the identified popular content to the device.

2. The method of claim 1, wherein identifying the popular content comprises:
identifying the popular content based on a number of times users associated with the at least one parameter requested the popular content.

3. The method of claim 1, wherein identifying the popular content comprises:
identifying the popular content based on a number of times users associated with the at least one parameter viewed the popular content.

4. The method of claim 1, wherein identifying the popular content comprises:
identifying the popular content based on at least one of user interactions with content, lengths of user interactions with content, an annotation of content, popularity of annotations over time, or user communications associated with content.

5. The method of claim 1, wherein the at least one parameter comprises a geographic location.

6. The method of claim 1, wherein the at least one parameter comprises a period of time.

7. The method of claim 1, wherein the at least one parameter comprises a demographic of a user.

8. The method of claim 1, wherein the request for popular content further comprises a requested content type.

9. The method of claim 8, wherein the requested content type comprises at least one of a mobile webpage, a news article, a restaurant listing, a movie listing, and an object on a webpage.

10. The method of claim 1, wherein the device is a mobile device.

11. The method of claim 1, further comprising:
adjusting a ranking of the identified popular content based on at least one property associated with a user that submitted the request for popular content to provide the identified popular content in a contextually relevant manner.

12. A computer-readable storage medium comprising a set of instructions for providing popular content, the set of instructions to direct a processor to perform acts of:
receiving a request for popular content from a device, the request for popular content comprising at least one parameter associated with users that previously accessed the popular content;
identifying the popular content based on a frequency of users associated with the at least one parameter accessing the popular content; and
serving the identified popular content to the device.

13. The computer-readable storage medium of claim 12, wherein identifying the popular content comprises:
identifying the popular content based on a number of times users associated with the at least one parameter requested the popular content.

14. The computer-readable storage medium of claim 12, wherein identifying the popular content comprises:
identifying the popular content based on a number of times users associated with the at least one parameter viewed the popular content.

15. The computer-readable storage medium of claim 14, wherein identifying the popular content comprises:
identifying the popular content based on at least one of user interactions with content, lengths of user interactions with content, an annotation of content, popularity of annotations over time, or user communications associated with content.

16. The computer-readable storage medium of claim 12, wherein the at least one parameter comprises at least one of a geographic location, a period of time, and a demographic of an user.

17. The computer-readable storage medium of claim 12, wherein the request for popular content further comprises a requested content type.

18. The computer-readable storage medium of claim 17, wherein the requested content type comprises at least one of a mobile webpage, a news article, a restaurant listing, a movie listing, and an object on a webpage.

19. The computer-readable storage medium of claim 12, further comprising a set of instructions to direct the processor to perform acts of:
adjusting a ranking of the identified popular content based on at least one property associated with a user that submitted the request for popular content to provide the identified popular content in a contextually relevant manner.

20. A system for providing popular content, the system comprising:
at least one server comprising a popularity module running in conjunction with at least one processor of the at least one server, the popularity module configured to:
receive a request for popular content, the request for popular content comprising at least one parameter associated with users that previously accessed the popular content
identify the popular content based on a frequency of users associated with the at least one parameter accessing the popular content; and
serve the identified popular content to a device.

21. The system of claim 20, wherein to identify the popular content, the popularity module is further operative to identify the popular content based on a number of times users associated with the at least one parameter requested the popular content.

22. The system of claim 20, wherein to identify the popular content, the popularity module is further operative to identify the popular content based on a number of times users associated with the at least one parameter viewed the popular content.

23. The system of claim 20, wherein to identify the popular content, the popularity module is further operative to identify the popular content based on at least one of user interactions with content, lengths of user interactions with content, an annotation of content, popularity of annotations over time, or user communications associated with content.

24. The system of claim 20, wherein the at least one parameter comprises at least one of a geographic location, a period of time, and a demographic of an user.

25. The system of claim 20 wherein the request for popular content further comprises a requested document type, the requested document type comprising at least one of a mobile webpage, a news article, a restaurant listing, a movie listing, and an object on a webpage.
